(19) United States
(12) Patent Application Publication
(10) Pub. No.: US 2008/0182546 A1
(43) Pub. Date: Jul. 31, 2008

(54) Mobile phone capable of making internet calls, system and method using the same

(75) Inventors: Yu-Ching Wang, Taipei City (TW); Alexander Mou, Taipei City (TW); Shiuan-Ming Chen, Taipei City (TW); Chao-Hsien Lin, Taipei City (TW); Chien-Chih Wu, Taipei City (TW)

Correspondence Address: BACON & THOMAS, PLLC, 625 SLATERS LANE, FOURTH FLOOR, ALEXANDRIA, VA, 22314, US

(73) Assignee: ASUSTEK COMPUTER INC., Taipei City (TW)

(21) Appl. No.: 12/010,464

(22) Filed: Jan. 25, 2008

(30) Foreign Application Priority Data
Jan. 26, 2007 (TW) 096102967

(51) Int. Cl. H04M 11/00; H04B 1/38; H04Q 7/20

(52) U.S. Cl. 455/403; 455/557

(57) ABSTRACT

The invention relates to mobile phone capable of making internet calls, a system and a method for making internet calls via a computer by the same. The system includes a computer installed with communication software and a mobile phone capable of making internet calls. Moreover, via the system, the method includes the steps of: transmitting related data of a communication software to mobile phone capable of making internet calls by a computer, storing related data of the communication software in the mobile phone capable of making internet calls, and operating the communication software of the computer to phone or answer a phone according to related data of the communication software by the mobile phone. Therefore, the main objective of the invention is to enable users to phone anytime and anywhere easily and enable the information needed by users to be shown completely by a wireless handheld electronic device.

### BACKGROUND OF THE INVENTION

1. Field of the Invention

The invention relates to a mobile phone and, more particularly, to a mobile phone capable of making internet calls, a system and a method using the same.

2. Description of the Related Art

Recently, since the Internet phone has developed maturely, the communication quality has been greatly improved. In addition, many users uses Internet phone to save communication expense. For example, Skype has a register of 0.14 billion members, and the average number of users online has reached five million.

However, most Skype users use Skype in the following three manners which are shown in FIG. 1, FIG. 2, and FIG. 3. The first manner is using a Bluetooth earphone 91A as a telephone transmitter, the second manner is using a common microphone 91B as a telephone transmitter, and the third manner is purchasing hardware (such as a Skype phone 91C) as a telephone transmitter. When users use the Internet phone in one of the above manners, they have to pay additional money to purchase hardware, or the telephone transmitter is limited by the “wire”, or no screen can be used to show the operating message. Even if the Skype phone does not necessarily have a screen for showing, and if the Skype phone has a screen, the screen only shows simple content, which does not make any special help for users in use.

Therefore, how to provide a mobile phone capable of making internet calls to save the above problems has become a subject needed to be solved urgently.

### BRIEF SUMMARY OF THE INVENTION

To solve the above problem, the main objective of the invention is to provide a mobile phone capable of making internet calls, which can transmit data duplexly with a computer by Bluetooth. The computer is installed with a communication software. The mobile phone includes a Bluetooth module paired with the computer to receive related data of a communication software, a microcontroller electrically connected to the Bluetooth module and a storage unit electrically connected to the microcontroller to store related data of the communication software.

After the microcontroller processes, a phone call can be made or answered by operating the communication software of a computer according to related data of the communication software, and the information needed by the user can be completely shown by the existing wireless handheld electronic device. Thus, a phone call can be made or answered anytime and anywhere.

As stated above, the mobile phone of the invention also can operate the communication software of the computer to edit and transmit instant messages to other users according to related data of the communication software via the microcontroller, and a multi-party call also can be started.

The invention also provides a system for making internet calls via a computer by a mobile phone capable of making internet calls. The system includes a computer installed with a communication software and a mobile phone capable of making internet calls including a Bluetooth module paired with the computer to receive related data of a kind of communication software, a microcontroller electrically connected to the Bluetooth module and a storage unit electrically connected to the microcontroller to store related data of the communication software.

After the microcontroller processes, a phone call can be made or answered by operating the communication software of a computer according to related data of the communication software. Therefore, another objective of the invention is to provide a system for making internet calls via a computer by a mobile phone capable of making internet calls, so that an existing wireless handheld electronic device can be combined with the computer at home to archive the objective of phoning or answering a phone easily.

The invention utilizes the above system to provide a method for making internet calls via a computer by a mobile phone capable of making internet calls. The method includes the following steps: at first, transmitting related data of a communication software to a mobile phone capable of making internet calls by a computer, and storing related data of the communication software by the mobile phone capable of making internet calls; at last, operating the communication software of the computer to phone or answer a phone according to related data of the communication software by the mobile phone capable of making internet calls. Therefore, an another objective of the invention is to provide a method for making internet calls via a computer by a mobile phone capable of making internet calls. The method can provide simple operating steps for phoning or answering a phone easily, and related functions of communication software of the computer can be used.

In addition, after users use a mobile phone capable of making internet calls to store related data of the communication software, they also can operate the communication software of the computer according to related data of the communication software by the mobile phone capable of making internet calls. They can browse information of other users, control to retain or switch over a phone call, hang up, amend personal information of a user, receive instant messages transmitted from other users, edit and transmit instant messages to other users, start multi-party communication, start chatting room, manage group list, transmit short message, cancel, add or change information of other users, add other users to the group, remove other users of the group, cancel, add or change information of group, set incoming call ring and read communication history record.

In the invention, a wireless handheld electronic device is combined with a computer at home, and simple operating steps are provided. Therefore, a user can phone or answer a phone easily by a mobile phone and uses various related functions of the communication software of the computer.

### BRIEF DESCRIPTION OF THE DRAWINGS

FIG. 1 is a schematic diagram showing the first conventional method for using the Internet phone.

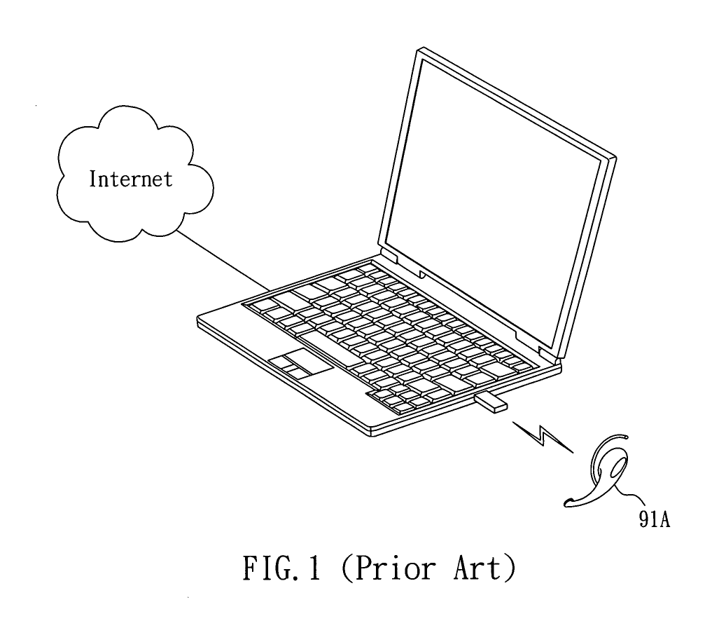

FIG. 2 is a schematic diagram showing the second conventional method for using the Internet phone.

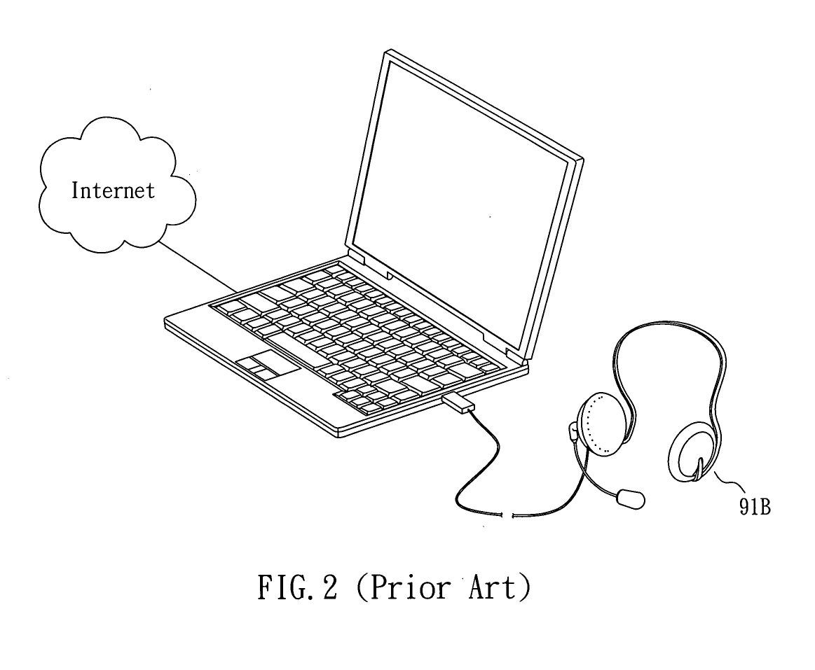

FIG. 3 is a schematic diagram showing the third conventional method for using the Internet phone.

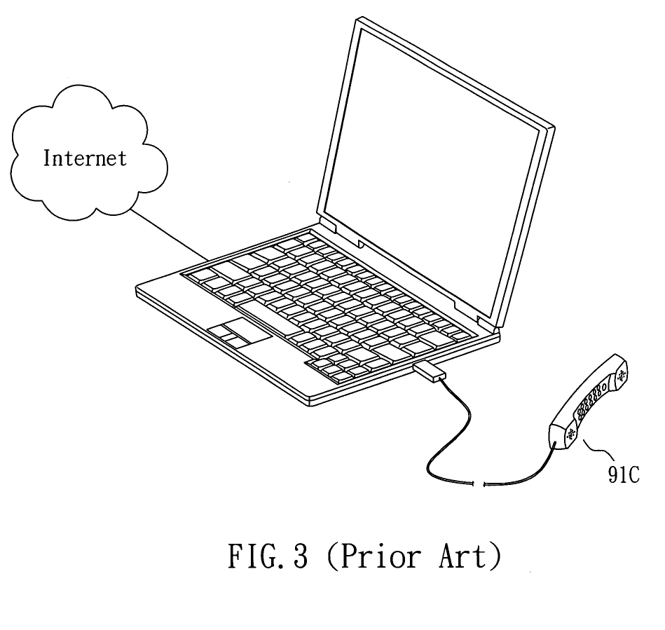

FIG. 4 is a system diagram of a preferred embodiment of the invention.

FIG. 5 is a block diagram showing the main configuration of a mobile phone capable of making internet calls and the computer which cooperates with the mobile phone capable of making internet calls of a preferred embodiment of the invention.

FIG. 6 is a schematic diagram showing a mobile phone capable of making internet calls showing related information of Skype of a preferred embodiment of the invention.

FIG. 7A and 7B is schematic diagrams showing a mobile phone capable of making internet calls showing the information about option function of a preferred embodiment of the invention.

FIG. 8 is a flowchart of a preferred embodiment of the invention.

FIG. 9A, 9B and 9C are schematic diagrams showing a mobile phone capable of making internet calls showing information about instant message function of a preferred embodiment of the invention.

### DETAILED DESCRIPTION OF THE EMBODIMENTS

Detailed embodiments are described herein below to illustrate the implementing manner of the invention, so that people having ordinary skills in the art can easily understand the advantages and effects of the invention via the content disclosed by the specification easily.

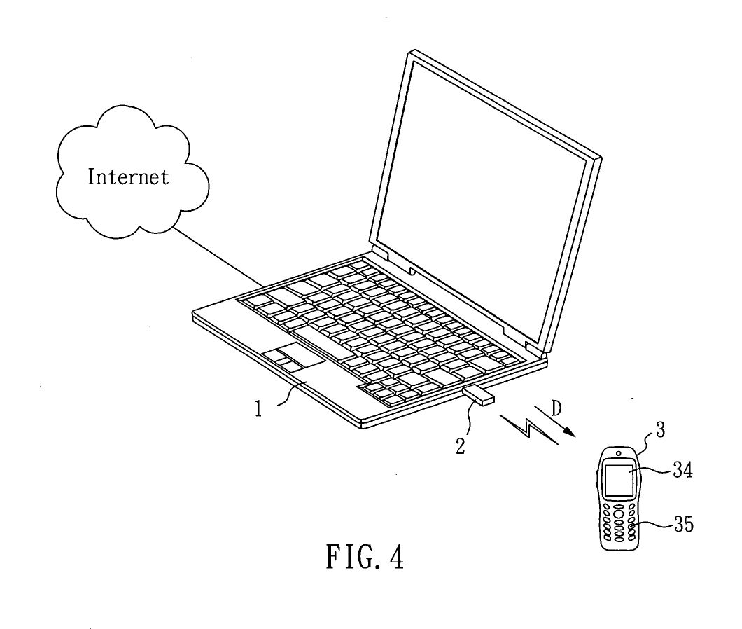

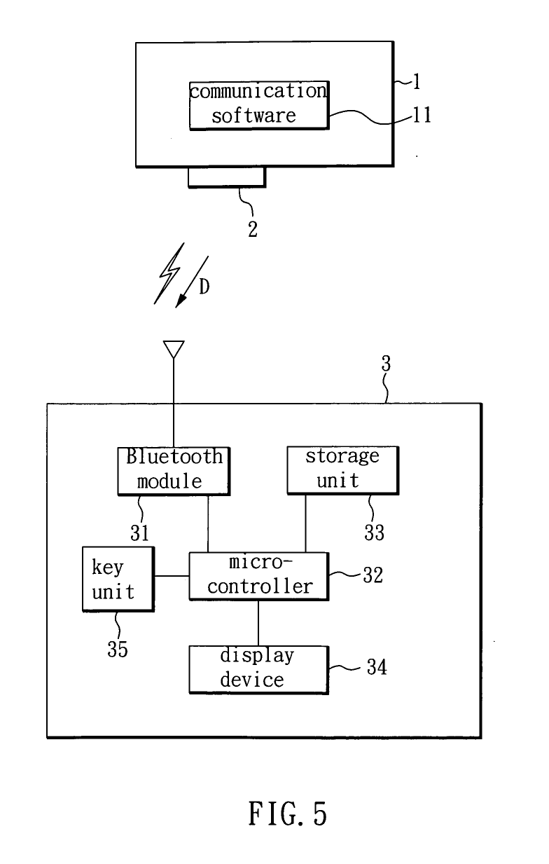

Please refer to FIG. 4 and FIG. 5 simultaneously. FIG. 4 is a system diagram showing a preferred embodiment of the invention. FIG. 5 is a block diagram showing the main configuration of a mobile phone capable of making internet calls and the computer which cooperates with the mobile phone capable of making internet calls of a preferred embodiment of the invention. In the invention, a system for making internet calls via a computer by a mobile phone capable of making internet calls includes a computer 1 and a mobile phone capable of making internet calls 3.

The computer 1 is installed with a communication software 11 and equipped with a Bluetooth transceiver 2 outside. In the embodiment, the communication software 11 is Skype, and it also can be other equivalent communication software. Skype provides an Internet phone function which has a better communication quality. As long as both two communicating sides install the software in the computers, no matter how far they are apart, they can communicate via the software without time limitation. However, before using the system to make an Internet phone call by the mobile phone capable of making internet calls 3, users must start the Skype communication software 11 in the computer 1 first and login the Skype by the member account number.

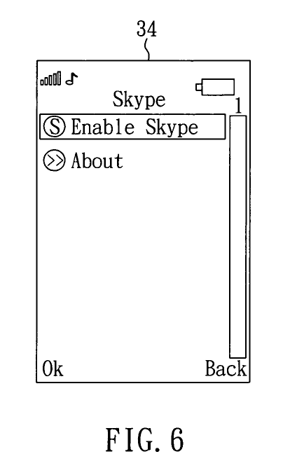

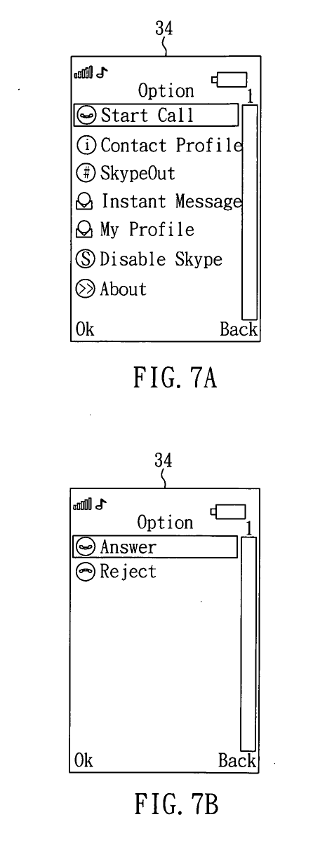

The mobile phone capable of making internet calls 3 includes a Bluetooth module 31, a microcontroller 32, a storage unit 33, a display device 34 and a key unit 35. The Bluetooth module 31 can be paired with the Bluetooth transceiver 2 of the computer 1 to receive related data D of the communication software, and related data D includes personal information of a user or information of other users and so on. The microcontroller 32 is electrically connected to the Bluetooth module 31. In addition, the storage unit 33 is electrically connected to the microcontroller 32 to store related data D of the communication software received by the Bluetooth module 31 from the computer 1 and processed by the microcontroller 32. The display device 34 is electrically connected to the microcontroller 32 to show the operating status of the communication software 11 of the computer 1. For example, a user uses the mobile phone capable of making internet calls 3 to select Enable Skype from the operating options of the Skype (as shown in FIG. 6), and then needed service function can be selected from the options (as shown in FIG. 7A and FIG. 7B).

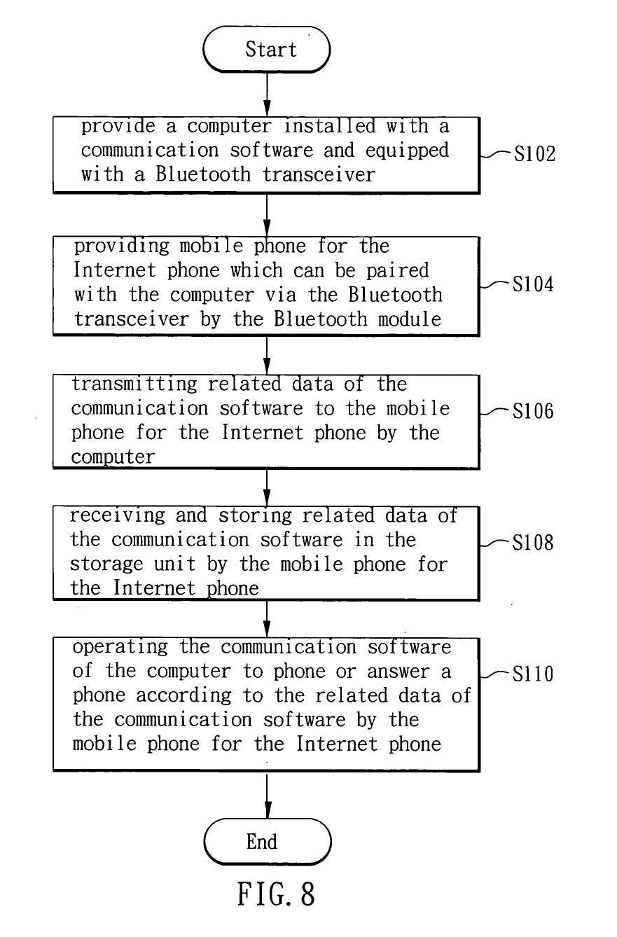

FIG. 8 is a flowchart showing a method of a preferred embodiment of the invention. Please refer to FIG. 4, FIG. 5, FIG. 7A and FIG. 7B simultaneously.

The invention provides a method for making internet calls via a computer by a mobile phone capable of making internet calls. First, a computer device 1 installed with communication software and equipped with the Bluetooth transceiver 2 is provided (step S102), and usually a user must start the Bluetooth transceiver 2 and the communication software 11 via the computer 1 first and finish the logon. Then, the mobile phone capable of making internet calls 3 is provided and has a function of Bluetooth transmission to be paired with the Bluetooth transceiver 2 of the computer 1 (step S104), and the data can be transmitted duplexly.

Before the mobile phone is used to make an Internet phone call, related data D of the communication software in the computer 1 must be transmitted to the mobile phone capable of making internet calls 3 first (step S106), and related data D of the communication software is stored in the storage unit 33 of the mobile phone capable of making internet calls 3 (step S108). Then, the communication software 11 of the computer 1 can make a phone call according to related data D of the communication software via the key unit 35 of the mobile phone capable of making internet calls 3 (step S110). For example, if users want to operate the communication software 11 of the computer 1 to make a phone call according to related data D of the communication software 11, user can select the needed Start Call from the options shown in FIG. 7A, or they also can select needed SkypeOut from the options, so user can make a communication with others via Internet or Public Switched Telephone Network (PSTN). In addition, when a phone call comes, users can operate the communication software 11 of the computer 1 to answer the phone according to related data D of the communication software 11. That is, they can select the needed Answer or Reject from the options shown in FIG. 7B. In addition, after users select Answer, if a waiting call exists simultaneously, they can further select to hang up, retain or switch over the answered phone call, or start a multi-party call to receive another phone call easily.

However, after the users finish answering the phone, if they want to send short messages to the other side, they can review the answered telephone number via the function of communication history record and reply the short message via the function of short message transmission.

Users can use the mobile phone capable of making internet calls 3 to store related data D of the communication software, and operate the communication software 11 of the computer 1 to phone or answer a phone according to related data D of the communication software by the key unit 35 of the mobile phone capable of making internet calls 3. In addition, they further can use the mobile phone capable of making internet calls 3 to operate the communication software 11 of the computer 1 to amend the personal information of the users such as display icons or names of users according to related data D of the communication software by the key unit 35.

In addition, users also can operate the communication software 11 of the computer 1 to manage the group list to cancel, add or change the information of the group. Furthermore, users further can review the information of other users of each group and select other users who want to add to the group, or remove other users of the group, or cancel, add, or change the information of other users.

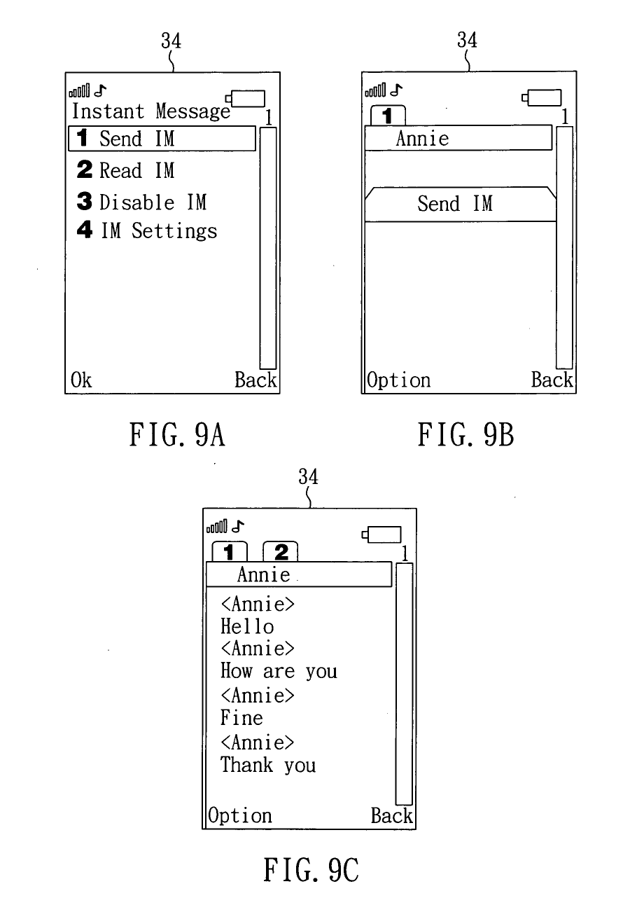

The communication software 11 usually has the function of transmitting or receiving the instant message. The system also can receive instant messages for other users, or edit and transmit instant messages to other users, even start a chatting room to provide the environment of multi-party chat and message transmission to make users enjoy the fun of chat anytime and anywhere easily. For example, if users want to transmit an instant message to other users, they can selected needed Instant Message from the options shown in FIG. 7A, and select the needed Send IM from the Instant Message shown in FIG. 9A to edit and transmit the message to the selected other users, as shown in FIG. 9B. In addition, users also can review all the instant messages, as shown in FIG. 9C.

Therefore, the present invention provides an existing wireless handheld electronic device combined with a computer at home, and simple operating steps are provided. Therefore, a user can phone or answer a phone easily by a mobile phone and uses various related functions of the communication software of the computer.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A mobile phone for transmit data with a computer installed a communication software duplexly by Bluetooth, the mobile phone comprising:
a Bluetooth module paired with the computer to receive related data of the communication software;
a microcontroller electrically connected to the Bluetooth module; and
a storage unit electrically connected to the microcontroller to store related data of the communication software;
wherein the microcontroller operates the communication software of the computer to phone or answer a phone call according to related data of the communication software.

2. The mobile phone according to claim 1, wherein the microcontroller operates the communication software of the computer to edit and transmit instant messages to other users according to related data of the communication software.

3. The mobile phone according to claim 1, wherein the microcontroller operates the communication software of the computer to start a multi-party call according to related data of the communication software.

4. A system forphoning via a computer by a mobile phone capable of making internet calls, the system comprising:
a computer installed with a communication software; and
a mobile phone comprising:
a Bluetooth module paired with the computer to receive related data of the communication software;
a microcontroller electrically connected to the Bluetooth module; and
a storage unit electrically connected to the microcontroller to store related data of the communication software;
wherein the microcontroller operates the communication software of the computer to phone or answer a phone according to related data of the communication software.

5. A method for phoning via a computer by a mobile phone capable of making internet calls, the method comprising the steps of:
transmitting related data of a communication software from the computer to the mobile phone;
utilizing the mobile phone to store related data of the communication software; and
utilizing the mobile phone to operate the communication software of the computer to phone or answer a phone call according to related data of the communication software.

6. The method according to claim 5, wherein the mobile phone further can be paired with the computer via a Bluetooth module to receive related data of the communication software.

7. The method according to claim 5, wherein the mobile phone further can show the operating status of the communication software via a display device.

8. The method according to claim 5, wherein the mobile phone further can be used to operate the communication software to phone or answer a phone call via a key unit.

9. The method according to claim 5, wherein after the mobile phone stores related data of the communication software, the mobile phone further can operate the communication software of the computer to review information of other users according to related data of the communication software.

10. The method according to claim 5, wherein after the mobile phone stores related data of the communication software, the mobile phone capable of making internet calls further can operate the communication software of the computer to control to remain or switch over a phone call according to related data of the communication software.

11. The method according to claim 5, wherein after the mobile phone stores related data of the communication software, the mobile phone f further can operate the communication software of the computer to hang up according to related data of the communication software.

12. The method according to claim 5, wherein after the mobile phone stores related data of the communication software, the mobile phone further canoperate the communication software of the computer to amend personal information of users according to related data of the communication software.

13. The method according to claim 5, wherein after the mobile phone stores related data of the communication software, the mobile phone can operate the communication software of the computer to receive or transmit instant messages transmitted from other users according to related data of the communication software.

14. The method according to claim 5, wherein after the mobile phone stores related data of the communication software, the mobile phone further can operate the communication software of the computer to start multi-party call according to related data of the communication software.

15. The method according to claim 5, wherein after the mobile phone stores related data of the communication software, the mobile phone further can operate the communication software of the computer to start a chatting room according to related data of the communication software.

16. The method according to claim 5, wherein after the mobile phone stores related data of the communication software, the mobile phone further can operate the communication software of the computer to manage groups list according to related data of the communication software.

17. The method according to claim 5, wherein after the mobile phone stores related data of the communication software, the mobile phone further can operate the communication software of the computer to transmit short messages according to related data of the communication software.

18. The method according to claim 5, wherein after the mobile phone stores related data of the communication software, the mobile phone further can operate the communication software of the computer to cancel, add or change information of other users according to related data of the communication software.

19. The method according to claim 5, wherein after the mobile phone stores related data of the communication software, the mobile phone further can operate the communication software of the computer to add other users to groups or remove other users of groups according to related data of the communication software 20. The method according to claim 5, wherein after the mobile phone stores related data of the communication software, the mobile phone further can operate the communication software of the computer to cancel, add or change information of groups according to related data of the communication software.

21. The method according to claim 5, wherein after the mobile phone stores related data of the communication software, the mobile phone further can operate the communication software of the computer to set incoming call ring according to related data of the communication software.

22. The method according to claim 5, wherein after the mobile phone stores related data of the communication software, the mobile phone further can operate the communication software of the computer to review communication history record according to related data of the communication software.
